(19) United States
(12) Patent Application Publication
(10) Pub. No.: US 2011/0111849 A1
(43) Pub. Date: May 12, 2011

(54) Spatially Aware Mobile Projection

(75) Inventors: Randall B. Sprague, Hansville, WA (US); Joshua O. Miller, Woodinville, WA (US); David Lashmet, Bainbridge Island, WA (US); Andrew T. Rosen, Lynnwood, WA (US)

(73) Assignee: MICROVISION, INC., Redmond, WA (US)

(21) Appl. No.: 13/007,508

(22) Filed: Jan. 14, 2011

Related U.S. Application Data
(63) Continuation-in-part of application No. 11/761,908, filed on Jun. 12, 2007.
Application No. 11/761,908 is a continuation-in-part of application No. 11/635,799, filed on Dec. 6, 2006.
(60) Provisional application No. 60/742,638, filed on Dec. 6, 2005.

(51) Int. Cl. A63F 9/24; G06F 3/033

(52) U.S. Cl. 463/31; 345/158

(57) ABSTRACT

A spatially aware apparatus includes a projector. Projected display contents can change based on the position, motion, or orientation of the apparatus. The apparatus may include gyroscope(s), accelerometer(s), global positioning system (GPS) receiver(s), radio receiver(s), or any other devices or interfaces that detect, or provide information relating to, motion, orientation, or position of the apparatus.

### RELATED APPLICATIONS

Benefit is claimed under 35 U.S.C. §120 as a Continuation-in-Part (CIP) of U.S. application Ser. No. 11/761,908, entitled “Spatially Aware Mobile Projection” by Sprague et al., filed Jun. 12, 2007, which claims benefit under 35 U.S.C. §120 as a Continuation-in-Part (CIP) of U.S. application Ser. No. 11/635,799, entitled “Projection Display with Motion Compensation” by Willey et al., filed Dec. 6, 2006, which claims benefit under 35 U.S.C. §119(e) of U.S. Provisional Application Ser. No. 60/742,638, entitled “Projection Display with Motion Compensation” by Willey et al., filed Dec. 6, 2005, all of which are incorporated herein by reference in their entirety for all purposes.

### FIELD

The present invention relates generally to projection devices, and more specifically to mobile projection devices.

### BACKGROUND

Projection systems are commonly in use in business environments and in multimedia entertainment systems. For example, desktop projectors are now popular for sales and teaching. Also for example, many public theatres and home theatres include projection devices. As with many other electronic devices, projectors are shrinking in size, their power requirements are reducing, and they are becoming more reliable.

### BRIEF DESCRIPTION OF THE DRAWINGS

FIG. 1 shows a spatially aware mobile projection system;

FIG. 2 shows a spatially aware mobile projector system with various input systems and output systems;

FIG. 3 shows a spatially aware mobile projection system with a wireless interface;

FIG. 4 shows a spatially aware mobile projection system with a wired interface;

FIG. 5 shows a spatially aware mobile projection system;

FIG. 6 shows a micro-projector;

FIG. 7 shows a spatially aware gaming apparatus;

FIG. 8 shows a communications device with a spatially aware mobile projector;

FIG. 9 shows a spatially aware mobile projection system used as a sports teaching tool;

FIG. 10 shows a system that includes both fixed and mobile projectors;

FIG. 11 shows a spatially aware mobile projection system used as a medical information device;

FIG. 12 shows a spatially aware mobile projection system used as an aid to navigation;

FIG. 13 shows a spatially aware mobile projection system having an appendage with a projection surface;

FIG. 14 shows a vehicular mobile projection system;

FIG. 15 shows a flowchart in accordance with various embodiments of the present invention; and

FIG. 16 is a graphical depiction of a portion of a bitmap memory showing offset pixel locations according to an embodiment.

### DESCRIPTION OF EMBODIMENTS

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

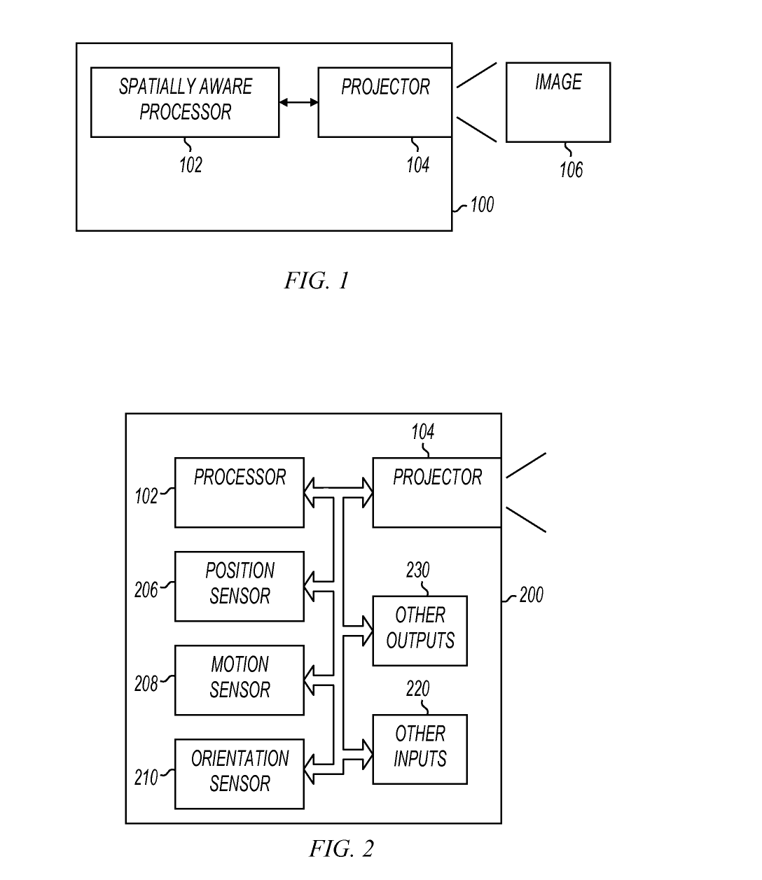

FIG. 1 shows a spatially aware mobile projection apparatus. Mobile projection apparatus 100 includes projector 104 and processor 102. Projector 104 projects an image 106. Processor 102 has information relating to the spatial position, orientation, and/or motion of apparatus 100, and is referred to as being “spatially aware.” The term “spatially aware” describes access to any information relating to spatial characteristics of the apparatus. For example, as described above, a spatially aware processor within an apparatus may have access to information relating to the position, motion, and/or orientation of the apparatus.

Projector 104 may change the projected image in response to information received from processor 102. For example, processor 102 may cause projector 104 to modify the image in response to the current position of apparatus 100. Further, processor 102 may cause projector 104 to modify the image in response to motion of the apparatus. Still further, processor 102 may cause projector 104 to modify the image in response to a current orientation or change in orientation of the apparatus. In some scenarios, processor 102 may recognize the spatial information without changing the image. For example, processor 102 may change the image in response to spatial information after a delay, or may determine whether to change the image in response to spatial information as well as other contextual information.

Processor 102 may obtain spatial information and therefore become spatially aware in any manner. For example, in some embodiments, apparatus 100 may include sensors to detect position, motion, or orientation. Also for example, the position/motion/orientation data may be provided to apparatus 100 through a wired or wireless link. These and other embodiments are further described below with reference to later figures.

In some embodiments, processor 102 provides image data to projector 104, and changes it directly. In other embodiments, image data is provided by a data source other than processor 102, and processor 102 indirectly influences projector 104 through interactions with the image data source. Various embodiments having various combinations of image data sources are described further below with reference to later figures.

Projector 104 may be any type of projector suitable for inclusion in a mobile apparatus. In some embodiments, projector 104 is a small, light, battery-operated projector. For example, projector 104 may be a micro-electro mechanical system (MEMS) based projector that includes an electromagnetic driver that surrounds a resonating aluminum-coated silicon chip. The aluminum coated silicon chip operates as a small mirror (“MEMS mirror”) that moves on two separate axes, x and y, with minimal electrical power requirements. The MEMS mirror can reflect light as it moves, to display a composite image of picture elements (pixels) by scanning in a pattern. Multiple laser light sources (e.g., red, green, and blue) may be utilized to produce color images.

The combination of a spatially aware processor and a projector allow apparatus 100 to adjust the displayed image based at least in part on its location in time and in space. For example, the displayed image can change based on where the apparatus is pointing, or where it is located, or how it is moved. Various embodiments of spatially aware projection systems are further described below.

Spatially aware projection systems may be utilized in many applications, including simulators, gaming systems, medical applications, and others. As described further below, projected images may be modified responsive to spatial data alone, other input data of various types, or any combination. Further, other output responses may be combined with a dynamic image to provide a rich user interaction experience.

FIG. 2 shows a spatially aware mobile projector system with various input systems and output systems. System 200 includes projector 104, processor 102, position sensor 206, motion sensor 208, orientation sensor 210, other input devices 220, and other output devices 230. Processor 102 and projector 104 are described above with reference to FIG. 1. In embodiments represented by FIG. 2, processor 102 becomes spatially aware via data provided by one or more of position sensor 206, motion sensor 208, and orientation sensor 210.

Position sensor 206 may include any type of device capable of providing global or local position information for system 200. On the local scale, position can be relative: e.g., the distance to an established waypoint, or with respect to the previous position of the device. Such distances can be measured accurately with sonic, laser, radar, or other electromagnetic (EM) emissions, where the timing of the return of the EM pulse is compared to the speed of the emission, then cut in half. Alternatively, a gyroscope or perpendicular arrangement of accelerometers can register change of position, from a normative starting point. On the global scale, position can be triangulated from a constellation of Global Positioning Satellites, or from the Galileo constellation, once the latter is established in orbit. Various embodiments may also include directional microphones, rangefinders, wireless location systems, and other types of position sensors. In operation, position sensor 206 may provide the position information to processor 102.

Motion sensor 208 may include any type of device capable of providing motion information for system 200. Motion may be measured as a change in position or orientation over time. For example, motion sensor 208 may include gyroscopes, accelerometers, altimeters/barometers, rangefinders, directional microphones, internal visual or non-visual (e.g., sonic) movement detectors, external visual or non-visual (e.g., sonic) movement detectors keyed to the device, etc. In operation, motion sensor 208 may provide the motion information to processor 102.

Orientation sensor 210 may include any type of device capable of providing orientation information for system 200. Like position sensing, orientation may be measured on a local or global scale. Local orientation may be considered relative or absolute. Orientation information may be gathered using a second set of positional sensors: e.g., either a second gyroscope or array of accelerometers; or a second receiver or transmitter/receiver. Thus, the device can establish its front facing with respect to its back facing.

On the global scale, orientation measurement can be accomplished with a compass or digital compass. In some embodiments two gyroscopes are used to measure orientation. In other embodiments two sets of accelerometers are employed to measure orientation. In still further embodiments, these technologies are mixed. In any of these embodiments, a digital compass is optionally included. In operation, orientation sensor 210 may provide the orientation information to processor 102.

In addition to the example sensors described above, system 200 may include any device that measures absolute or relative time. For example, time may be measured accurately by an internal device, such as a digital clock, atomic clock or analog chronometer, or by reference to an external time source, such as a radio clock, a Loran clock, a cellular network's clock, the GPS clock, or the Network Time Protocol (NTP) and Simple Network Time Protocol (SNTP) of the World Wide Web. Time information may be provided directly to processor 102, or may be combined with other spatial data.

Other input devices 220 may include any number and type of input devices. Examples include, but are not limited to: tactile input devices such as buttons, wheels, and touch screens; sound input devices such as omnidirectional microphones and directional microphones; image or light sensors such as Charge Coupled Device (CCD) cameras, and light sensitive diodes; and biological or radiological sensors. System 200 is not limited by the number and/or type of input devices.

Other output devices 230 may include any number and type of output devices. For example, output devices 230 may include audio output through speakers, headphone jacks, and/or audio out cables. Further, output devices 230 may include wired or wireless interfaces to transmit information to other systems. Also for example, output devices 230 may include a control interface or housing that gives tactile feedback or force feedback or related dynamic responses. These haptic outputs can be controlled for at the hardware and software level, with respect to shaking all or a portion of system 200, and/or the shaking of an acoustical speaker or speakers, and/or the natural resonance(s) of the device, and/or gyroscope(s) or accelerometer(s) within the device.

In operation, system 200 may modify the response of one of the other output devices 230 responsive to spatial information. For example, if system 200 is moved, a sound output device or haptic output device may provide an appropriate response depending on the application. This output response may be in addition to, or in lieu of, a change in the image projected by projector 104.

Also in operation, system 200 may modify the image displayed based on one or more of the other input devices 220. For example, if system 200 has a thumbwheel turned, or if a speech command is received and recognized, the image may be modified. The image may be changed in response to only a tactile input device or only a sound input device, or the image may be changed in response to these input devices as well as in response to spatial information.

Combining multiple types of input data with spatial and time data to create a combined image response and other multimedia output response provides for rich user interaction with the system. The resulting device is well adapted to interact with a human user's multiple senses. Plus, it better harnesses a human user's ability to combine speech and motion. For instance, multiple outputs may include a visible image, sound and haptic feedback, while multiple inputs may include gestures, spoken words and button pressing. Such natural synergies are fully encompassed by the various invention embodiments.

For example, an input synergy may comprise a user swinging a handheld projector while twisting its grip, and verbally grunting at the point of intersection with a virtual object. This can be used in an educational simulator, to teach topspin in tennis, or to hit a golf ball.

Also for example, an output synergy may be a matter of simultaneous timing. For example, the image of a ball leaving a tennis racket, combined with the “trumm” sound of racket strings, and a force feedback surge in the grip of the device. Alternatively, the outputs can overlap in timing: e.g., approaching footsteps are heard before a creaky door is opened, within the confines of a video game.

In some embodiments, input or output channels may contribute position, motion, or orientation data, without reference to gyroscopes, accelerometers, GPS, or other spatial sensors. For example, directional microphones can orient the device with respect to the user, another fellow player in a simulation, an external set of speakers, or fixed obstacles, like walls. On the output side, two channel audio (stereophonic sound) can relay information about virtual world to one side or even behind a user. Any additional speakers further enrich a virtual world.

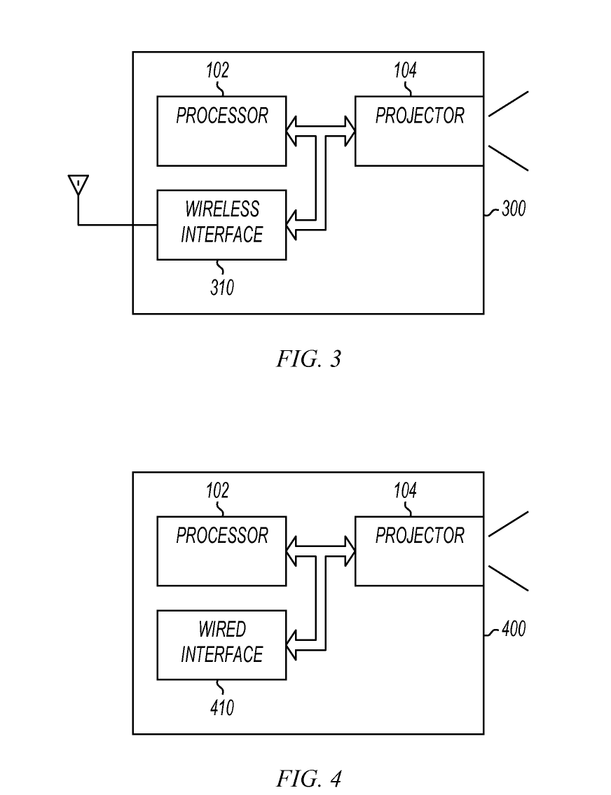

FIG. 3 shows a spatially aware mobile projection system with a wireless interface. System 300 includes processor 102, projector 104, and wireless interface 310. Processor 102 and projector 104 are described above with reference to previous figures. Wireless interface 310 may be unidirectional or bidirectional. For example, wireless interface 310 may only receive information such as: spatial information from external sensors; spatial information from other spatially aware projection systems; image data; control data; or the like. Also for example, wireless interface 310 may only transmit information such as: spatial information describing the position, motion, or orientation of system 300; control data; or image data to other computers or gaming consoles or cellular telephones or other displays or projectors or other mobile projectors. In still further embodiments, wireless interface 310 both transmits and receives data wirelessly.

Wireless interface 310 may be any type of wireless interface. Examples include but are not limited to: ultra wideband (UWB) wireless; Infrared; WiFi; WiMax; RFID; cellular telephony; satellite transmission; etc.

In some embodiments, system 300 does not include spatial sensors, and spatial information is provided via wireless interface 310. In these embodiments (and others in which spatial information is not directly measured by the device), processor 102 is spatially aware even though the apparatus (system 300) does not include spatial (position/motion/orientation) sensors. In other embodiments, system 300 includes sensors, other input devices, and/or other output devices as described with reference to previous figures.

FIG. 4 shows a spatially aware mobile projection system 400 with a wired interface. Wired interface 410 serves the same purpose as wireless interface 310 (FIG. 3), but with a wired connection as opposed to a wireless connection. Wired interface can take any form, including a dedicated wire between multiple spatially aware projection devices, a dedicated wire between system 400 and a computer or game controller, or a jack to accept a networking cable such as an Ethernet cable.

In some embodiments, a spatially aware projection system includes both wired and wireless connections. For example, a wireless connection may be utilized to communicate with other spatially aware projection systems, while a wired connection may be used to couple the system to a network.

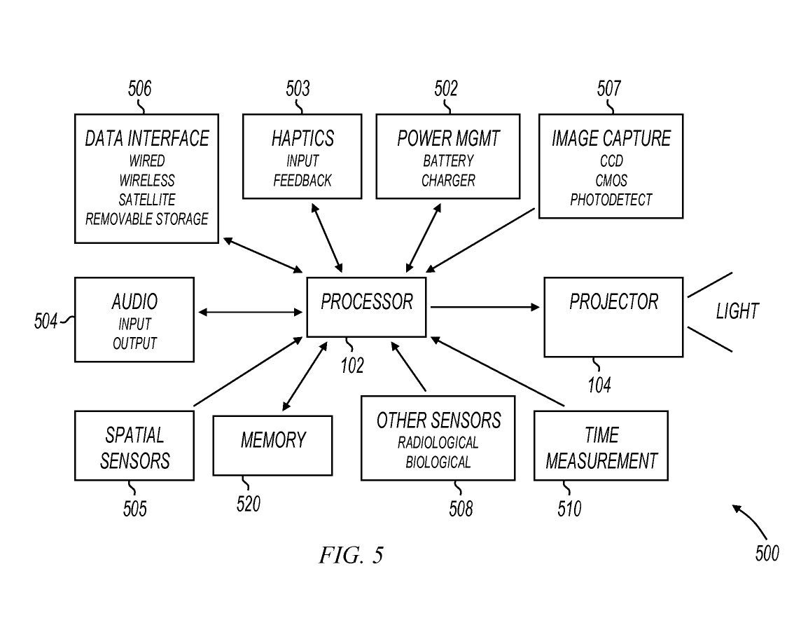

FIG. 5 shows a spatially aware mobile projection system. System 500 includes processor 102, projector 104, power management components 502, haptics components 503, audio components 504, spatial components 505, data interfaces 506, image capture components 507, other sensors 508, time measurement component 510, and memory 520.

Projector 104 receives digital output data from processor 102. As described above, in some embodiments, projector 104 is a MEMS device that includes an electromagnetic driver surrounding an aluminum-on-silicon mirror. Light from laser diodes inside the projection device hits the mirror, which moves along an x- and a y-axis to build a picture by combining digital picture elements (pixels). In some embodiments, processor 102 includes computer memory and digital storage. Any type of projector may be used; the various embodiments of the present invention are not limited by the projector technology used.

Memory 520 represents any digital storage component. For example, memory 520 may be an embedded storage device, such as a hard drive or a flash memory drive, or removable storage device, such as an SD card or MicroSD card. In some embodiments, memory 520 is a source of display data for projector 104. Also in some embodiments, memory 520 stores instructions that when accessed by processor 102 result in processor 102 performing method embodiments of the present invention. Additional removable storage is also described below with reference to data interface component 506.

Power management component 502 may include a portable source of electricity, such as a battery or rechargeable battery or portable fuel cell or solar panel or hand generator. Some embodiments also include a hard-wired or removable power cable, or a USB cable that includes electrical power along with data transmission. In many embodiments, a rechargeable battery and either a removable power cable and/or a USB cable are employed. In operation, processor 102 may help manage power, while electricity flows to the processor.

Haptics components 503 may include many different (e.g., three) different classes of tactile control interfaces. For example, the device may include a touch screen and/or buttons, triggers, dials and/or wheels which a user manipulates to control the device. Also for example, the device may include tactile sensory feedback when such a touch screen, button, trigger, etc, is manipulated, including varying the intensity of this feedback based on how hard or fast the control is operated. Also for example, the device may include kinesthetic feedback as directed by a user and/or a software program. For example, a recoil effect in response to specific control inputs or software outputs, such as firing a special weapon, or running in to a virtual wall in a simulation or game.

Note that any or all of these inputs or outputs may combine with any other input or output component to trigger a second-order response from the device. For example, a hand gesture combined with audio input such as spoken command words could cause the device to present a particular audio and visual effect, such as the sound of bells chiming and a shower of sparks to appear.

Audio component 504 includes audio input devices such as any number of microphones or directional microphones or audio-in jacks, and/or audio output devices such as any number of speakers or earphone jacks or audio-out jacks. Note that these audio inputs and outputs may supply positional information to the device, and/or the user. For example, directional microphones can help locate the position or orientation of the device with respect to a particular pattern or frequency of sounds. Also for example, directional speakers can help orient or position a user in space and time. For a combined example, the sounds coming out of the device can help the device locate its position or orientation, via its directional microphone.

Image capture components 507 may include any number of charged couple devices (CCD) or a CMOS digital cameras or photo-detectors. Note that such image capture components may also supply spatial information to the device. For example, photo-detectors can help locate the position or orientation of the device with respect to a particular pattern, and/or a particular wavelength of light. This detected light may be visible or invisible (ultraviolet or infrared) light put out by the projector 104, or it may be ambient light, or from some other light source integral to the device.

Time measurement may be provided by time measurement component 510. Time measurement component 510 may include any component capable of providing time data. For example, time measurement component 510 may include digital clock circuitry, or may include a GPS receiver.

Additional positional, motion, or orientation data may also come via the spatial components 505. For example, local position may be established via any number of gyroscopes and/or accelerometers. In some embodiments, these gyroscopes or accelerometers establish three perpendicular planes of motion: x, y, and z. To detect change in position over time (motion), such devices may utilize time data from time measurement component 510. Further, because other inputs or outputs of this device (such as tactile inputs, kinesthetic output or speaker resonance) may cause incidental motion, such positional “noise” may be removed by processor 102, as well as mechanically reduced by clever device design. Simply holding the device or moving with it over difficult terrain may also cause incidental movement, so again noise cancellation strategies are employed by the processor 102 and by device designers.

Like position, local orientation may be established by a second set of gyroscopes and/or accelerometers. This second set of positional data establishes the relationship of one part of the device with respect to another. Typically, this second set of positional components is set at the opposite side of the device, to maximize the signal to noise ratio. Whether this marks top and bottom or front and back or right and left is application-dependent.

Global position and orientation can be measured via the Global Positioning System (GPS) of geostationary satellites, and a digital compass, respectively. Alternative positional inputs include local or regional fixed wireless or satellite systems, such as the Galileo Constellation. External positional inputs and other position dependent data (such as haptic and/or audio and/or video data) may also be received via data interface 506. For example, a user may receive a severe storm warning over a wireless interface based on the global position of the device. Also for example, a user may receive a sale brochure or set of pictures or free music, when passing by a particular place of business. Such data may be stored or transmitted or outputted by the device, as the user or a software program permits.

Data interface 506 may also include a fixed or removable cable for bringing time, audio, visual, haptic and/or other data to the device, or sending tactile, audio, visual or positional data out. Such a data interface may also be a wireless solution, such as a cellular telephone, WiFi, WiMax or ultrawideband (UWB) radio transmitter/receiver, or a satellite transmitter/receiver. In addition, a removable digital storage device such as a SD card or MicroSD card may be used for data input and/or output.

Optionally, other sensors 508 may be included. For example, a radiological detector or biological sensor combined with GPS data could influence the audio, visual and/or haptic outputs of the device. Such optional sensing data may also be recorded or transmitted, as the user or a software program permits. Such additional sensors may supplement the work of a robot, for example. Alternatively, they could warn a user of dangerous environmental circumstances.

In the various embodiments of the present invention, projector 104 is capable of projecting light (522). This projected light may compose a still image, an invisible (ultra-violet or infrared) image, a moving image, or a pattern or flash of light. Thus, beyond displaying pictures, word images, or motion pictures, this projected light can encode information, or it can provide short-term illumination, including emergency signaling. For example, this device may allow emergency Morse Code transmissions, depending on user inputs, and/or software programs. Projector 104 may also use its primary projected light output or a secondary light output to illuminate a target for image capture.

System 500 may receive its source data for display either from a fixed digital storage medium such as a hard drive or flash memory card, or from a removable digital storage medium such as an SD card or micro SD, or from internal computation such as a video game or simulator software played on an embedded computer, or from a hard-wired connection such as a Universal Serial Bus (USB) cable, or from a wireless connection such as an ultra-wide-band (UWB) wireless receiver or transmitter/receiver.

Broadly speaking, data for visual projection and audio projection and haptic feedback, etc., can enter the device by many different means including through a wire or cable; through any sort of wireless transmission; the data can be generated internally, with or without additional input from the user; or the data can be stored internally in a digital memory storage device, such as a Flash memory card or a hard drive, or removable data storage devices, such as SD cards or micro SD cards. When inserted, such cards act as data stored internally, although by design they can be extracted easily, to be exchanged or transported freely.

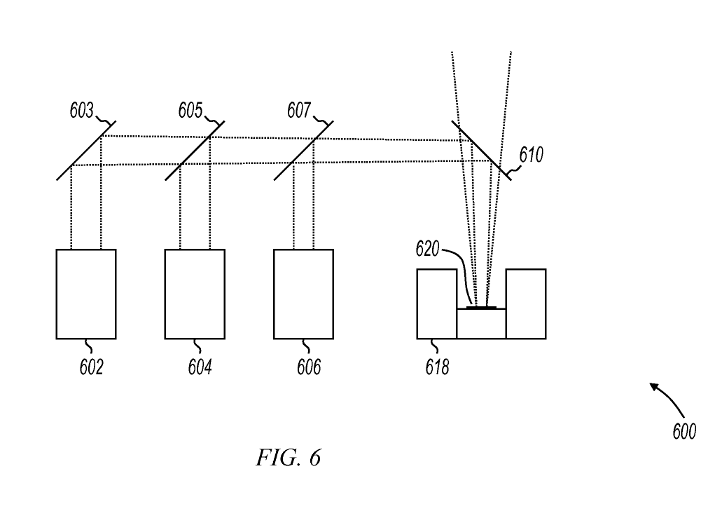

FIG. 6 shows a micro-projector suitable for use in the disclosed spatially aware embodiments. Projector 600 includes laser diodes 602, 604, and 606. Projector 600 also includes mirrors 603, 605, and 607, filter/polarizer 610, and MEMs device 618 having mirror 620. Red, green, and blue light is provided by the laser diodes, although other light sources, such as color filters or light emitting diodes (LED's) or edge-emitting LED's, could easily be substituted. One advantage of lasers is that their light is produced as a column, and this column emerges as a narrow beam. When each beam is directed at the MEMS mirror (either directly or through guiding optics) the colors of light can be mixed on the surface of the mirror, pixel by pixel.

This process of picture-building can be repeated many times per second, to reproduce moving pictures. Therefore, a MEMS mirror and three colored light sources can function like a traditional CRT monitor or television set, but without the metal and glass vacuum tube, and without the phosphors on a screen. Instead, this produces a small projector, with a nearly infinite focal point.

By using solid-state colored continuous beam laser diodes, it's possible to build such a projection device on the millimeter scale. Further, by modulating the power to each laser diode as needed to produce a particular color, it is possible to greatly reduce the electrical requirements of such a device. Together, this yields a projection device that can fit into a small form factor spatially aware device, and that can run reliably on its stored battery power. The MEMs based projector is described as an example, and the various embodiments of the invention are not so limited. For example, other projector types may be included in spatially aware projection systems without departing from the scope of the present invention.

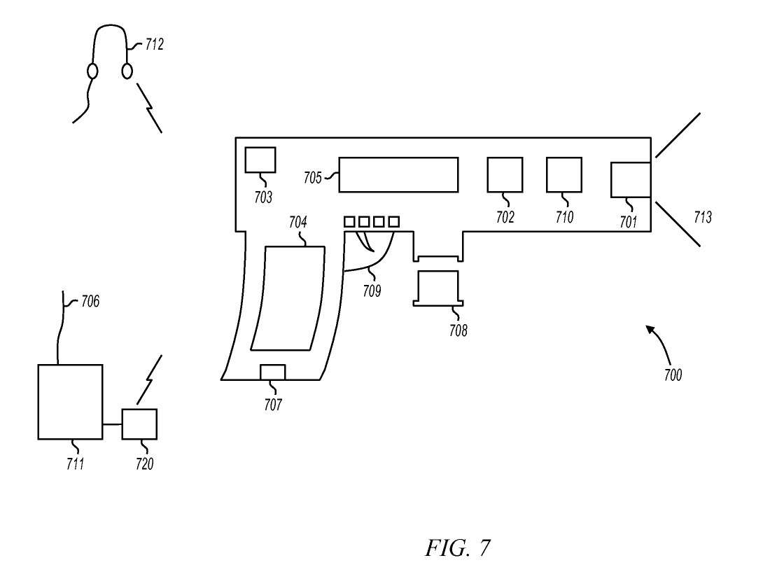

FIG. 7 shows a spatially aware gaming apparatus. Gaming apparatus 700 allows a user or users to experience a three dimensional virtual environment from a first person perspective, based on the position and/or orientation of the apparatus. For example, gaming apparatus 700 may be used in first person perspective games as well as other over-the-shoulder games, educational, medical and industrial simulators (coral reef, jungle canopy, inside a human heart or lung, underground looking for oil), and others. In general, gaming apparatus may be used in any virtual environment.

Many so-called “First Person Shooter” video game titles are already designed so that a user in front of a fixed display device can apparently see in any virtual direction, by scrolling with a mouse through the x and y axes. In these games, up and down with respect to the user—the z axis—are in fact extensions of x and/or y, as if the user were in the center of a sphere. Moving forward or backward, right or left, or upwards or downwards is accomplished by separate buttons or pedals, or some other input command (a virtual glove or voice commands, for example). Invention embodiments represented in FIG. 7 allow a more immersive experience for this same user, in part because the image is projected, and rather than scroll a mouse to move left, the user simply points the device left. In addition to the “first person” game genre, spatially aware gaming device 700 may be utilized for many other useful purposes, such as students taking a virtual tour of the rain forest canopy.

In operation, a user holds on to the housing 750, which in the embodiment shown is in the shape of a laser gun or handgun. Any grip surface or shape suitable for a human hand may be used. For example, housing 750 may be a laser rifle shape or a machine gun shape, a grenade launcher shape, etc. Some embodiments include additional lights or light-emitting diodes or fiber optic cables or small fixed displays (OLED panels or LED panels or LCD panels), for decoration or additional game-specific applications. Likewise, this housing may be of any material, any texture, and any color (including transparent).

A micro-projector 701 is partially enclosed by the housing. Micro-projector 701 may be any of the projector embodiments described herein. This micro-projector sends out images based on the device's position within the virtual reality program. However, the center point of the image (the x and y coordinates within a sphere) is determined by a gyroscope or accelerometers 702 positioned behind the micro-projector. This allows the display to move with the user to provide a much more immersive gaming experience. Plus, it gives the user physical exercise, while engaged in video game play.

To make this virtual experience more believable, this device also includes a speaker 703 and a haptic feedback mechanism 704 in the grip. The mass used for this force feedback may optionally be an on-board battery. This battery is recharged via a cable 706 that attaches to the cable connection 707. Potentially, this cable when connected can also input and output data: e.g., if this cable attached to a computer 711 on the user's belt, or in a backpack worn by the user. In these embodiments, a universal serial bus (USB) cable may be employed. Additionally, a removable battery 708 may be employed. This can be recharged outside the device, or while installed in the device, via the cable connection 707.

In some embodiments, a larger computer or gaming console communicates with this device via a wireless connection. Wires to a fixed console that does not move with the user poses a hazard, because as the user circles in the course of a gaming program, the user's legs could get tangled, and the user could fall. Thus, as illustrated, this larger gaming console or personal computer 711 is connected by a wireless connection such as a ultra wide band wireless radio (710, 720), where both the console and the device are equipped with transmitter/receivers. Similarly, a wireless headset 712 can by employed, with audio input and audio output capabilities. This headset could be wired to the device, to the gaming console or PC, or connected wirelessly—for example, by using Bluetooth. However, any other wireless, cellular or satellite connections could be freely substituted for any of these interconnects, as could direct cable connections to a larger object that moves with the user, such as a car.

It is also possible to dispense with an outside connection, and render images, sounds and/or haptic feedback based on user controls, the position of the device, and the on-board computer 705. In this simpler model, the battery need not be rechargeable, as long as it is replaceable. Alternatively, it's possible to make this device disposable, once an installed battery fails. But given the current cost of CPU's and micro-projectors versus the endurance of batteries, this alternative is not ideal. Instead, the stand-alone version of this device includes a powerful CPU and memory 705 with removable digital data storage (for example, a MicroSD Card), and a rechargeable battery 708 that can be removed or recharged while installed, via the cable connector 707.

Embodiments represented by FIG. 7 include a trigger 709 to enhance a “first person shooter” video gaming experience, although this is not a limitation of the present invention. The embodiments also include additional input buttons, which optionally include haptic feedback. Based on the position of this device, and such inputs as touch and sound, this device displays an image 713 in three dimensional space. Other outputs, such as sound from external speakers, may also be modified based on position. In most applications this displayed image lands on some surface. Uncluttered, high gain materials prove optimal display surfaces. But these are by no means required to significantly improve the experience of playing a “first person shooter” using the device depicted in FIG. 7.

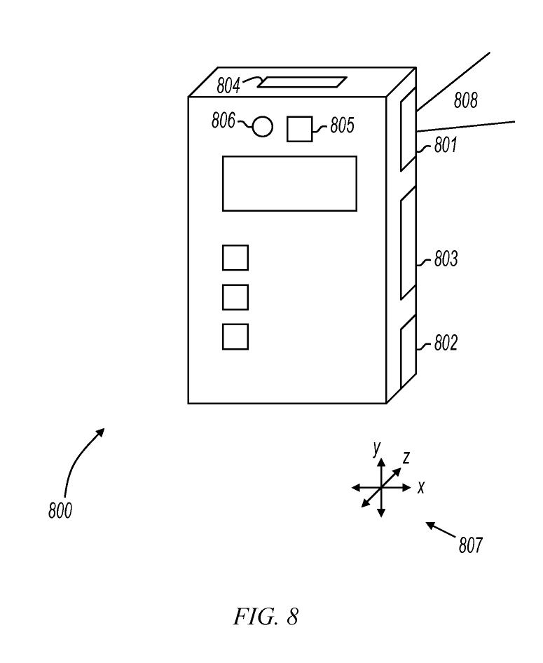

FIG. 8 shows a communications device with a spatially aware mobile projector. Communications device 800 may be any type of device usable for communications, including for example, a cellular phone, a smart phone, a personal digital assistant (PDA), or the like. The communications device 800 includes a window or projection lens 801 to pass light 808 from an internal projector. Similar to other embodiments of spatially aware projection systems described above, communications device 800 may include accelerometers 802, which note changes in position over time across three perpendicular axes: x, y and z 807. Further, the device may be connected to a larger network via a wireless (for example, WiMax) or cellular connection 803, or this device can accept data messages via an unregulated spectrum (for example, WiFi) connection. In this manner, positional data can inform other users or other computers about the user's position in time and space. Positional data also allows complex gesturing and gesturing plus other key input combinations (plus voice, plus tactile, etc) as higher-order control commands. Typical outputs from this device include sound, video and haptic feedback.

Communications device 800 may be used for may different applications including video conferencing where a user on one side of the device is captured on a video file by a CCD or CMOS camera 806, with the user optionally illuminated by an LED light source 805. This captured video (with or without audio) may be transmitted to a second user, who is positioned facing the camera on a similar device. In this mode, the second user's captured image is displayed by the micro-projector in the first device. At the same time, the first user's captured image is displayed by the micro-projector in the second device. Thus, large-format video conferencing is possible, using two small devices. Because this device also includes removable digital storage 804, such real-time conferences can also be saved for later playback, in this same device or in a separate digital display device.

Communications device 800 may also function as a gaming device, similar to the operation of gaming device 700 (FIG. 7). In these embodiments, communications device 800 may rely on a cellular network or other communications network for game-specific data. Thus, instead of a PC or gaming console, the gaming software platform could be server-based, or based on a cluster of computers or supercomputer(s). Communications device 800 can treat intentional motion of the user as input, which the device passes up the cellular network. Likewise, combinations of gestures and buttons pushed, and/or voice commands, go back to a centralized computer. Data can then come back down the wireless network 803 from the central computer to the end node device 800.

A hybrid function for this device includes gaming applications combined with video conferencing. For instance, a stylized version (or ‘avatar’) of the first user could be transmitted to the second user. This sort of avatar conferencing may be position and/or orientation dependent. For example, as one user looks towards a second user in a crowded room, the network notes this change in relative position, and the avatars change appearance. This explains how two users of avatar conferencing can find each other in the real world, even if the users have never met.

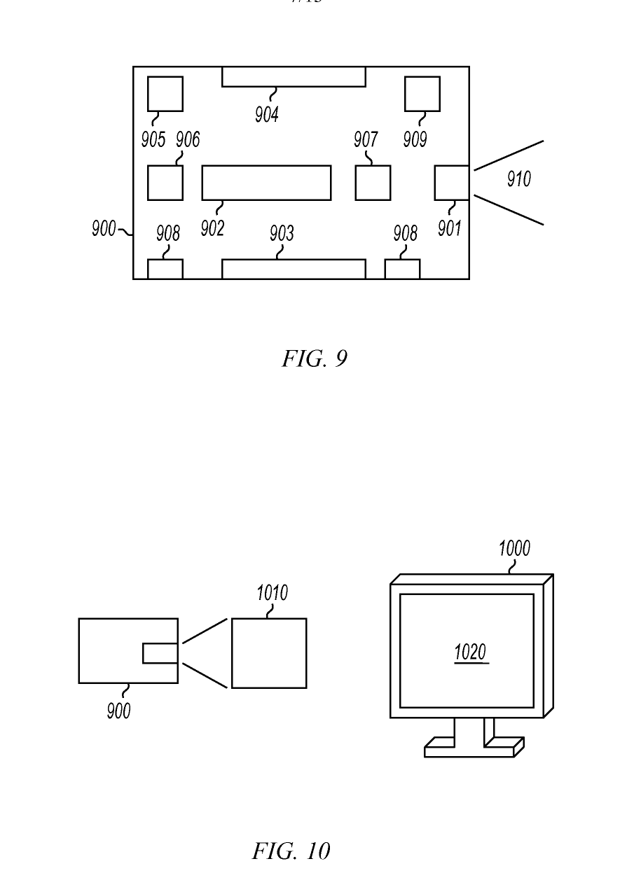

FIG. 9 shows a spatially aware mobile projection system used as a sports teaching tool. In these embodiments, the housing 900 may be cylindrical as shown, or may be another shape. A covering material to improve a user's grip may optionally be included. Soft synthetic rubber cleans up easily and compresses, plus it allows a firm grip. The housing and the cover partially enclose a micro-projector 901 that emits light 910 through a transparent dust cover, window, or projection lens.

In these embodiments, the device can help teach sports that involve sticks or handles: such as golf, croquet, tennis, racket ball, badminton, lacrosse, curling, kendo, hockey, polo, jai alai, arnis de mano, jo-jitsu, etc. The device can include two sets of gyroscopes or accelerometers, both of which can define up to three perpendicular planes x, y, and z. These gyroscopes or accelerometers are placed in opposite ends of the device 906, 907, so that the position and the attitude of the device—its pitch, yaw and roll—can be measured through time and space. Thus, this particular device may also prove useful in physical therapy: to diagnose, record and improve a user's range of motion.

Haptic feedback 904 may be included to indicate contact with another object: catching the ball in lacrosse, or hitting the wall in racquetball, for example. Alternatively, haptic feedback can help define the proper range of motion in physical therapy, or help guide a sword stroke, or to learn putting topspin on a serve in tennis. The realism of this teaching simulation is improved with audio output 909, which may take the form of a small speaker or the like. In some embodiments, an ultrawideband wireless interface 905 is included, and audio may optionally be delivered via wireless headphones. Two cable jacks 908 allow for data input and output, and allow for recharging the removable battery 903. A central processing unit 902 coordinates audio, video, haptics, positional and orientation data, as described above.

In some embodiments, the housing 900 may be formed to mimic the grip of a specific handle type. For example, a mobile projection device may be in the shape of a golf grip with the projector pointing out the bottom to display a virtual golf club head. As a user moves the grip, the projector can vary the distance between a virtual club head and a virtual ball. Audio output can simulate the “click” of contact. Touch sensitive inputs can confirm proper finger position and the pressure from a user's palm muscles. And haptic feedback can provide a single tap to the user, when the clubface and virtual ball intersect.

FIG. 10 shows a system that includes both fixed and mobile projectors. A mobile projector 900 projecting image 1010 may be used in conjunction with any number of fixed displays 1000 projecting image 1020 to create compatible or related content. For example, in a golf game simulator, the mobile projector can simulate a golf ball and a golf club, while the fixed display screen shows the flagstick and the hole (or ‘cup’), so that a user moving the projector appears to make contact with the club head and the ball; the ball then advances towards the cup; meanwhile, a second fixed display shows the changing leader board, and a third fixed display shows a gallery of spectators cheering.

Also for example, two micro-projector devices may be used to teach two-sword techniques in kendo, or two-hand techniques in Arnis. In these embodiments, the mobile projectors may include wireless connection to allow communication with each other, and/or with a third computer. Further, one or more fixed displays can be combined with multiple spatially aware projection devices to serve as a source of sports action (for example, an instructor serving the ball in tennis) or as a goal (in golf, the cup; in hockey, the net). This second display may otherwise show a virtual or live coach, who can give instructions and critique a user's moves, based on telemetry from the device.

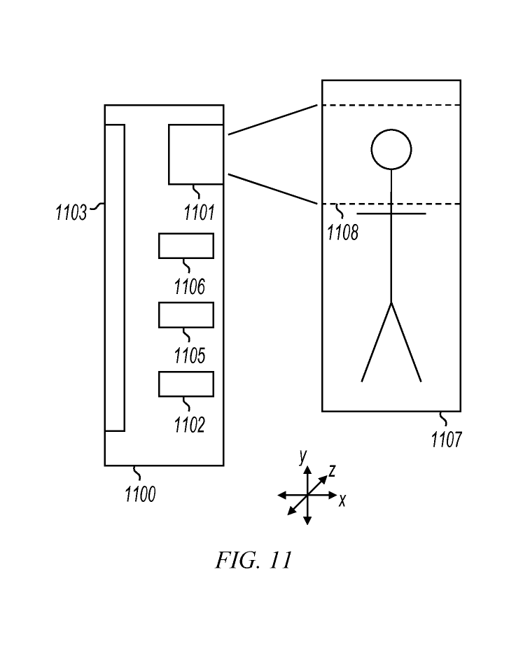

FIG. 11 shows a spatially aware mobile projection system used as a medical information device. In these embodiments, a small portable computer 1100 such as a tablet PC, Personal Digital Assistant (PDA), or Blackberry device has medical data stored within it, and/or has access to external medical data via a wireless network 1106. This device also includes a projector 1101 capable of displaying medical images, such as CAT scans or PET scans or MRI scans or ultrasound scans or X rays or pathology slides or biopsy sections, etc. Any other text, numerical field, image, video or coded optical information can also be displayed. In general, any portion 1108 or a complete 1107 virtual medical image can be projected and reviewed based on voice, touch and/or gestures of the user.

In some embodiments, device 1100 includes touch feedback through touch screen 1103. Audio in and audio out may also be included. In some embodiments, device 1100 also includes spatial sensors such as accelerometers 1102, to track a user's gestures in three perpendicular planes (x, y and z). A central processing unit 1105 coordinates these three control inputs, and reduces systemic noise. Thus, as a user gestures with this device, the image 1108 changes as the CPU directs.

A mobile projection device such as device 1100 can allow doctors and technicians to review medical images without resorting to a fixed display screen. For example, gestures, touch screens and haptic feedback allow doctors and/or technicians to navigate through a full body CAT scan with great facility, improving the speed and accuracy of medical services.

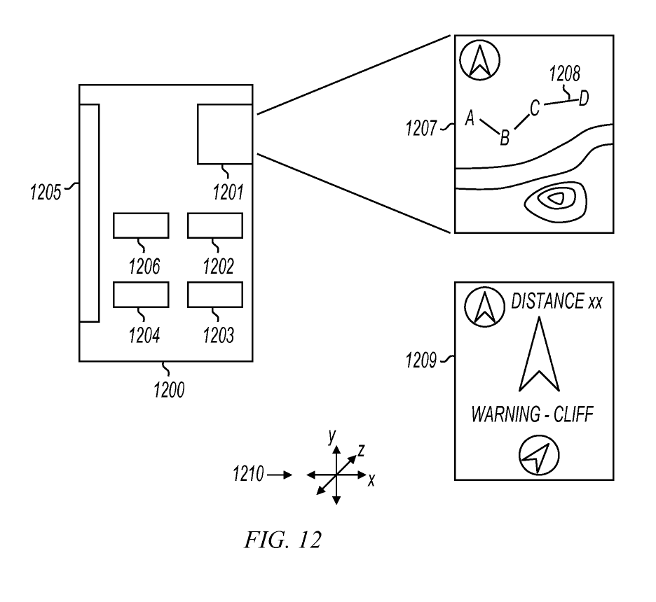

FIG. 12 shows a spatially aware mobile projection system used as an aid to navigation. System 1200 includes a projector 1201. In some embodiments, system 1200 also includes GPS navigation device 1203. System 1200 may optionally include a fixed display screen (not shown). Projector 1201 can display traditional GPS navigation data, such as topographical maps 1207 and the user's route within this map 1208.

Some embodiments include an orientation sensor such as a digital compass to allow the device to act as a day or night guiding beacon, where shining the projector on the ground provides a display 1209 showing the proper direction of travel, and/or the distance to a waypoint, and/or the location of any known hazards or points of interest. Haptic interfaces 1205 and aural alarms 1206 can reinforce the beacon's signals—for example, when a known hazard is approached, or when a waypoint is successfully passed.

Further, by adding gyroscopes or accelerometers 1204, this device can recognize if the user drops it, setting off an audio-visual alarm until the device is recovered. These gyroscopes or accelerometers also can function in cooperation with the device's buttons, to allow more complex gesture-based control inputs: for example, to switch between map and beacon modes. Adding a pedometer function to the gyroscope or accelerometers also allows motion tracking 1210 when GPS signals fade: for example, in a canyon, a complex of caves, or inside a building.

Gyroscopes or accelerometers can also help account for tilt in a digital compass. Digital compasses work by measuring the Hall effect in two crossed magnetic fields. But the earth is a sphere, and the magnetic center is deep under ground. So, digital compasses are calibrated to work while horizontal. Typically, this is accomplished with a bubble gauge, and leveling motion by the user. But gyroscopes or accelerometers can do this digitally: for example, whenever the compass is horizontal, the device can take a bearing.

System 1200 has many applications including route mapping and sightseeing. For example, a spatially aware mobile projection device can help trekkers plan a route and then follow it by projecting digital compass and GPS coordinates onto a high-gain map material, onto a snowfield, or onto the path itself. Also for example, some embodiments may include an internet connection to provide access to other data such as a bus schedule. Users could map the streets of a foreign city, find their location, and then find the closest way back home.

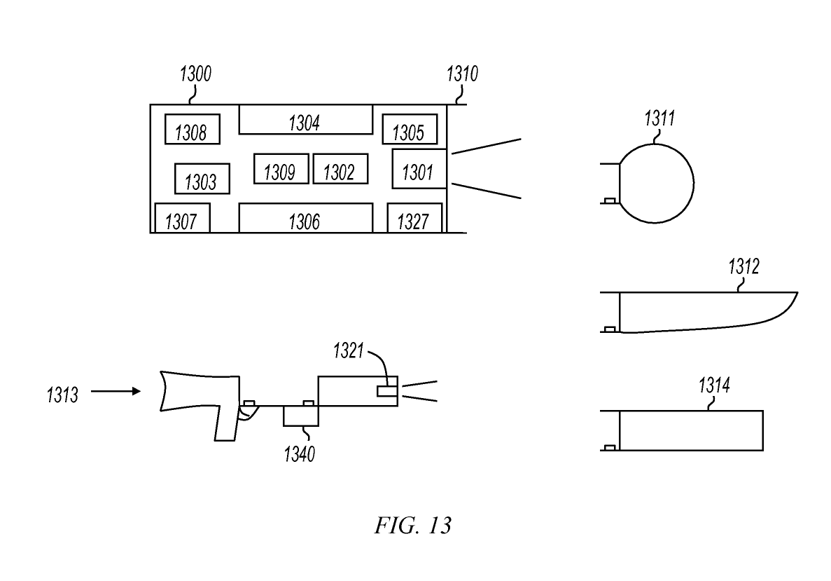

FIG. 13 shows a spatially aware mobile projection system having an appendage with a projection surface. System 1300 includes projector 1301 capable of projecting an image. In some embodiments, system 1300 also includes spatial sensors such as two gyroscopes or two sets of accelerometers (1302, 1303). In other embodiments, system 1300 may receive spatial data from alternate sources such as from a directional microphone 1305. Such spatial information is coordinated by a central processing unit 1309, and potentially transmitted to a second computer, via an ultrawideband wireless transmitter/receiver 1308. Battery 1306 may be recharged by a power source coupled to cable jack 1307. A second cable jack 1327 can support headphones or a data in/out cable.

In basic principle, embodiments of system 1300 are similar previously described embodiments, but system 1300 accepts attachments with projection surfaces. For example, a transparent or translucent plastic sword attachment 1312 connected to the device by a clip 1310 can capture and re-direct some of the light emitted by projector 1301. This sword could appear to glow blue when enemies approach, within a video game simulation. Or it could turn red in the midst of a battle. A wand attachment 1314 works much the same way. However, this attachment can be hollow, so that some light emerges from its tip. Alternatively, the tip of this wand could include a lens, to broaden or narrow the emergent light. With any of these attachments, the immersive quality of the gaming experience is improved with haptic feedback 1304.

A third attachment to the device in FIG. 13 is a transparent or translucent globe 1311. Such a globe may be completely spherical; may be shaped like a head or face; alternatively, it could be shaped like flames. For example, when the attachment is a globe, this combined device may display a hemisphere of world weather in real time, or in historic time, or in accelerated time. Further, in some embodiments, globe 1311 may be composed of a transparent touch-sensitive material. This control pathway could use the forward interface jack 1327. Also for example, when the globe is shaped like a face, the device could be used for video conferencing. Again, this face could be touch-sensitive. For a further example, when the globe is shaped like flames, the device can emit light that appears as flames. The colors or patterns of these flames can change based on voice commands and/or gestures and/or location. Such a device would make a novel and useful souvenir at a large venue such as the Olympic Games.

Further attachment embodiments include a rifle stock 1313, which attaches to both interfaces (1307, 1327) at the bottom of the device. In these embodiments, there is an additional battery 1340 that attaches to the forward interface 1327, and a trigger that attaches to the back interface 1307. There may also be a second projector 1321, at the front of the attachment. In these embodiments, the core device 1300 illuminates the rifle barrel; for example, if this were a laser rifle for playing a video game. In this arrangement, light from the core micro-projector 1301 fills the barrel either before or at the same time that light emerges from the forward projector 1321.

The various attachments to the spatially aware mobile projector include projection surfaces that help shape its light output, such as a transparent sword, or rifle barrel, or magic wand, or pointer, or globe, or flames. In some embodiments, separate attachments are not provided, and each shaped projection surface is a fixed appendage to the mobile projector. The term “appendage” is meant to encompass all possible projection surfaces, whether fixed, removable, or otherwise. The various attachments are not necessarily shown in the same scale as system 1300.

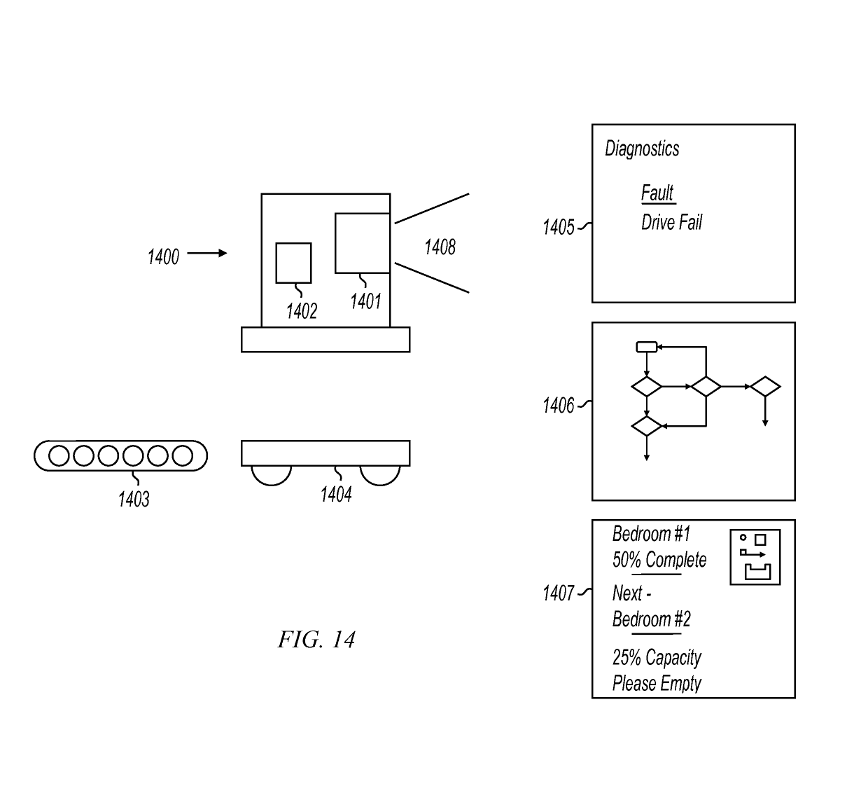

FIG. 14 shows a vehicular mobile projection system. System 1400 includes spatially aware processor 1402 and projector 1401 to project light 1408. System 1400 may be a vehicle, whether driven by a human, remotely controlled, or automatic. In some embodiments, the vehicle is an autonomous robot. As pictured, this robot is propelled by tracks 1403 or wheels 1404, although any other means of locomotion may be freely substituted: wings, propellers, rotor blades, magnetic levitation, a cushion of air, helium buoyancy, mechanical legs, etc. The common features among these robotic vehicles are a micro-projector 1401 and a spatially aware processor 1402 to control it, so that changes in the position or condition of the vehicle inform changes in the projected image 1408.

For example, projector 1401 can display its own diagnostic evaluations 1405, if it has an internal error that stops its progress. Alternatively, the robot can display the program or course of action it has taken in the past, and/or the course of action it is likely to take in the future 1406. Further, because this robot is aware of its position, it can also map and display areas where it has been, or where it is expected to go (1407). These maps may include tactile, sonic, visible, invisible, thermal, radiation, and/or chemical data, with broad and novel utility in commercial, military, industrial, entertainment or medical applications.

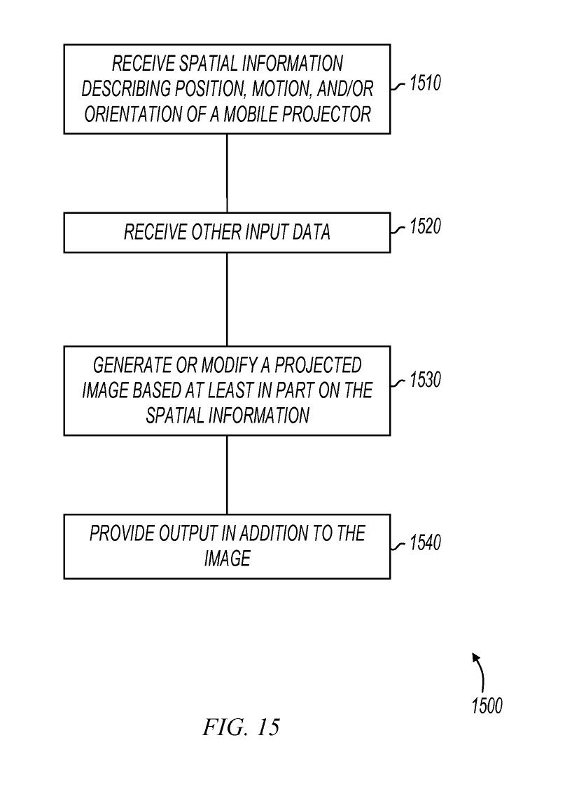

FIG. 15 shows a flowchart in accordance with various embodiments of the present invention. In some embodiments, method 1500, or portions thereof, is performed by a mobile projector, a spatially aware processor, or other spatially aware device, embodiments of which are shown in previous figures. In other embodiments, method 1500 is performed by an integrated circuit or an electronic system. Method 1500 is not limited by the particular type of apparatus performing the method. The various actions in method 1500 may be performed in the order presented, or may be performed in a different order. Further, in some embodiments, some actions listed in FIG. 15 are omitted from method 1500.

Method 1500 is shown beginning with block 1510 in which spatial information is received describing position, motion, and/or orientation of a mobile projector. The spatial information may be received from sensors co-located with the mobile projector, or may be received on a data link. For example, spatial information may be received from gyroscopes, accelerometers, digital compasses, GPS receivers or any other sensors co-located with the mobile projector. Also for example, spatial information may be received on a wireless or wired link from devices external to the mobile projector.

At 1520, other input data is received. “Other input data” refers to any data other than spatial information. For example, a user may input data through buttons, thumbwheels, sound, or any other means. Also for example, data may be provided by other spatially aware mobile projectors or may be provided by a gaming console or computer.

At 1530, an image to be projected is generated or modified based at least in part on the spatial information. For example, the image may represent a first person's view in a game, or may represent medical information relating to a diagnostic. As the mobile projector is moved, the image may respond appropriately. The image may be generated or modified based on the other input data in addition to, or in lieu of, the spatial information.

At 1540, output in addition to image modification is provided. For example, additional output (or feedback) in the form of sound or haptics may be provided as described above. Any type of additional output may be provided without departing from the scope of the present invention.

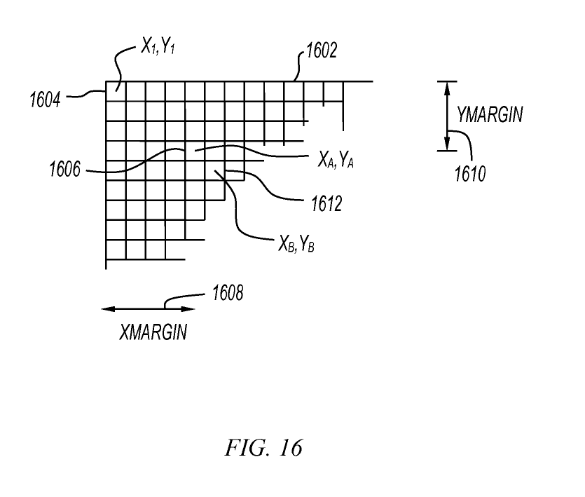

FIG. 16 is a graphical depiction of a portion of a bitmap memory showing offset pixel locations according to an embodiment. A bitmap memory 1602 includes memory locations X, Y corresponding to the range of pixel locations the display engine is capable of projecting. The upper left possible pixel 1604 is shown as X₁, Y₁. Nominally, the image extent may be set to a smaller range of pixel values than what the display engine is capable of producing, the extra range of pixel values being “held in reserve” to allow for moving the projected image across the bitmap to compensate for image shake. The upper left nominally projected pixel 1606 is designated (X_{A}, Y_{A}). The pixel 1606 corresponds to a location that produces a projection axis directed in a nominal direction, given no image shake. The pixel 1606 is offset horizontally from the pixel 1604 by an XMARGIN value 1608 and offset vertically from pixel 1604 by a YMARGIN value 1610. Thus, the amount of leftward horizontal movement allowed for compensating for image shake (assuming no image truncation is to occur) is a number of pixels equal to XMARGIN and the amount of upward vertical movement allowed is YMARGIN. Assuming a similar margin on the right and bottom edges of the bitmap, similar capacity is available respectively for rightward horizontal and downward vertical movement.

For an illustrative situation where the projection axis has (at least theoretically) shifted upward by one pixel and leftward by one pixel due to shake, the controller shifts the output buffer such that the pixel 1612, designated (X_{B}, Y_{B}), is selected to display the upper left pixel in the image. Thus, the projection axis is shifted downward and to the right to compensate for the physical movement of the projection display upward and to the left.

According to some embodiments, the margin values (e.g. XMARGIN and YMARGIN) may be determined according to a selected gain and/or a detected amount of image shake. That is, larger amplitude shake may be accommodated by projecting a lower resolution image that provides greater margins at the edge of the display engine's available field of view.

In some applications, image shake may result in large translation or rotation would nominally consume all of the available margin (e.g. XMARGIN and YMARGIN). According to some embodiments, the controller may strike a balance, for example by compensating for some or all of the image instability by truncating the projected image, by modifying gain of the stabilization function, by providing a variable gain stabilization function, by modifying display resolution, etc.

According to some applications, the image is selected to be larger than the field of view of the display engine. That is, the XMARGIN and YMARGIN margins may be negative. In such a case, the user may pan the display across the larger image space with the controller progressively revealing additional display space. The central image may thus remain stable with the image shake alternately revealing additional information around the periphery of the central area. Such embodiments may allow for very large display space, large image magnification, etc.

Although the present invention has been described in conjunction with certain embodiments, it is to be understood that modifications and variations may be resorted to without departing from the spirit and scope of the invention as those skilled in the art readily understand. Such modifications and variations are considered to be within the scope of the invention and the appended claims.

What is claimed is:

1. An apparatus comprising:
a mobile projector operable to project into a field of view;
a processing unit coupled to provide an image from display data to the mobile projector, wherein the display data represents a display space larger than the field of view; and
a source of information describing motion of the mobile projector;
wherein the processing unit is responsive to the information describing the motion of the mobile projector to modify the image provided to the mobile projector to progressively reveal additional display space as the mobile projector is panned to create a virtual environment from a user's first person perspective.

2. The apparatus of claim 1 wherein the source of information describing motion comprises at least one accelerometer.

3. The apparatus of claim 1 wherein the source of information describing motion comprises at least one gyroscope.

4. The apparatus of claim 1 wherein the source of information describing motion comprises a wireless interface to retrieve the information from an external device.

5. The apparatus of claim 1 wherein the source of information describing motion comprises a wired interface to retrieve the information from an external device.

6. An apparatus comprising:
a mobile projector operable to project into a field of view;
a processing unit coupled to provide an image from display data to the mobile projector, wherein the display data represents a display space larger than the field of view; and
a source of information describing orientation of the mobile projector;
wherein the processing unit is responsive to the information describing the orientation of the mobile projector to modify the image provided to the mobile projector to progressively reveal additional display space as the mobile projector is panned to create a virtual environment from a user's first person perspective.

7. The apparatus of claim 6 wherein the source of information describing orientation comprises a compass.

8. The apparatus of claim 6 further comprising a motion sensor, wherein the processing unit is further responsive to a motion sensor.

9. The apparatus of claim 8 wherein the motion sensor comprises at least one accelerometer.

10. A portable gaming device comprising:
a grip suitable for a human hand;
a projector to project an image from the portable gaming device, the image being a subset of display data that represents a display space larger than can be projected; and
a spatially aware processing device to cause the projector to change the image based at least in part on movement of the portable gaming device to progressively reveal additional display space as the portable gaming device is panned to create a virtual environment from a user's first person perspective.

11. The portable gaming device of claim 10 further comprising a housing in the shape of a gun.

12. The portable gaming device of claim 10 further comprising a haptic feedback device.

13. The portable gaming device of claim 10 further comprising a sound output device.

14. The portable gaming device of claim 10 further comprising an accelerometer coupled to provide motion information to the processing device.

15. The portable gaming device of claim 10 further comprising a compass coupled to provide orientation information to the processing device.

16. A handheld device comprising:
a micro electro mechanical system (MEMS) based projector to display an image where the handheld device is pointed, the image being a subset of display data that represents a display space larger than can be projected; and
a spatially aware processing device to modify the image in response to motion of the handheld device to progressively reveal additional display space as the handheld device is panned to create a virtual environment from a user's first person perspective.

17. The handheld device of claim 16 further comprising a global positioning system (GPS) receiver coupled to provide position information to the processing device.

18. The handheld device of claim 16 further comprising an accelerometer coupled to provide motion information to the processing device.

19. The handheld device of claim 16 wherein the image includes information to guide a user operating the handheld device.

20. The handheld device of claim 16 further comprising a compass coupled to provide orientation information to the processing device.
